(19) United States
(12) Patent Application Publication
(10) Pub. No.: US 2010/0268639 A1
(43) Pub. Date: Oct. 21, 2010

(54) Characterizing Creditworthiness Credit Score Migration

(76) Inventors: Jeffrey A. Feinstein, Roswell, GA (US); Shane De Zilwa, Oakland, CA (US); Lisa M. Wice, San Francisco, CA (US); Victor Wykoff, Laguna Niguel, CA (US); Sheng-Tzu P. Jui, Dallas, TX (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/425,282

(22) Filed: Apr. 16, 2009

(51) Int. Cl. G06Q 40/00

(52) U.S. Cl. 705/38; 705/35

(57) ABSTRACT

Data comprising a request to generate a migration score is received (for example, by a first computer system). The migration score characterizes a likelihood of a change in a level of creditworthiness of a consumer subsequent to generation of a current credit score. Thereafter, future credit score migration for the individual is estimated (for example, by the first computer system) using a predictive model trained using historical creditworthiness data derived from a plurality of individuals. The historical creditworthiness data includes, for each individual, a historical credit score and empirical performance data subsequent to a scoring date for the historical credit score. Thereafter, the estimated future credit score migration is associated (for example, by the first computer system) with a migration score. Provision of the migration score can then be initiated. Related apparatus, systems, techniques and articles are also described.

### TECHNICAL FIELD

The subject matter described herein relates to techniques for generating migration scores characterizing consumer performance behavior relating to creditworthiness subsequent to a credit scoring date.

### BACKGROUND

Conventional techniques for credit scoring do not take into account how such scores might migrate in the future. That is, given a consumer's history, conventional techniques do not take into account whether a credit score is moving in a positive direction or negative direction.

### SUMMARY

Data comprising a request to generate a migration score is received (for example, by a first computer system). The migration score characterizes a likelihood of a change in a level of creditworthiness of a consumer subsequent to generation of a current credit score. Thereafter, future credit score migration for the individual is estimated (for example, by the first computer system) using a predictive model trained using historical creditworthiness data derived from a plurality of individuals. The historical creditworthiness data includes, for each individual, a historical credit score and empirical performance data subsequent to a scoring date for the historical credit score. Thereafter, the estimated future credit score migration is associated (for example, by the first computer system) with a migration score. Provision of the migration score can then be initiated.

The migration score can be provided either by displaying it on the first computer system or by transmitting data characterizing migration score from the first computer system to a second computer system.

User-generated input (which can be obtained, for example, via a graphical user interface) can provide contextual data. Such contextual data can be used in estimating the future credit score migration. The contextual data can, for example, characterize an event requiring credit. If the event is a loan, the contextual data can include, for example, one or more of loan length, loan amount, interest rate, and type of collateral for loan.

The predictive model can be any of a variety of models including, for example, a scorecard model.

The predictive model can identify a plurality of migration triggers that characterize events which when they occur, result in a change in creditworthiness of the individual that is above one from a range of pre-determined thresholds. Creditworthiness data for the individual can be monitored subsequent to the provision of the migration score to identify the occurrence of one or more events characterizing one or more migration triggers. Provision of an alert indicating that a migration trigger has been triggered can then be initiated. In addition, an updated migration score can be generated based on such a monitored migration trigger event. One such trigger could also include the passage of time wherein an updated migration score can be delivered at specific time intervals corresponding, for example, to a user's system management review cycle.

Articles are also described that comprise a machine-readable storage medium embodying instructions that when performed by one or more machines result in operations described herein. Similarly, computer systems are also described that may include a processor and a memory coupled to the processor. The memory may encode one or more programs that cause the processor to perform one or more of the operations described herein.

The subject matter described herein provides many advantages. By providing a predictive model that is not heavily correlated to either initial credit score or change in credit score, migration effects are not dominated and washed out by virtue of the high correlation with the standard risk score development approach. Therefore, score migration can be predicted, and this score migration can be used to build a better risk score or as an add-on to conventional risk scoring techniques.

For example, the migration score can be used to provide useful information as compared or in addition to the use of a non-migration score. The probability of migration can indicate that while a traditional score is indicative of some performance later in time, the traditional score is likely to change in the near future. As such, decisions using traditional metrics can be modified based on the probability that the traditional metric will itself change in the near future.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a method for calculating and providing a credit migration score;

FIG. 2 is a diagram illustrating performance prediction in relation to good and bad consumer performance with a first set of credit scores generated in October 2005 and a second set of credit scores generated in October 2006, for a population having credit scores within a predefined range at October 2005;

FIG. 3 is a diagram illustrating performance prediction in relation to score increases and decreases with a first set of credit scores generated in October 2005 and a second set of credit scores adjusted by a migration score, for a population having credit scores within a predefined range at October 2005;

FIG. 4 is a diagram illustrating performance prediction in relation to good and bad consumer performance with a first set of credit scores generated in October 2005 and a second set of credit scores adjusted by a migration score, for a population having credit scores within a predefined range at October 2005; and

FIG. 5 is a diagram illustrating bad performance rates for combinations of credit scores and migration scores, for a population having credit scores within a predefined range at October 2005.

### DETAILED DESCRIPTION

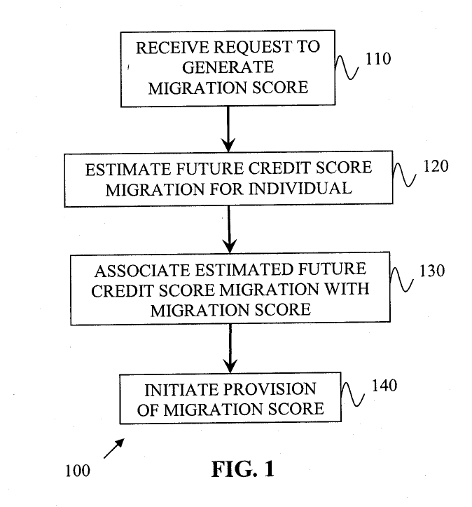

FIG. 1 is a process flow diagram 100, in which, at 110, data comprising a request to generate a migration score is received. The migration score characterizes a likelihood of a change in a level of creditworthiness of a consumer subsequent to generation of a current credit score. Thereafter, at 120, future credit score migration for the individual is estimated using a predictive model trained using historical creditworthiness data derived from a plurality of individuals. Such historical creditworthiness data includes, for each individual, a historical credit score and empirical performance data subsequent to a scoring date for the historical credit score. Subsequently, at 130, the estimated future credit score migration is associated with a migration score so that, at 140, provision of the migration score can be initiated.

The models described herein were derived using an analysis of a plurality of credit data samples, for example in this application, credit bureau data was used to predict the migration of a credit bureau risk score (i.e., credit history data characterizing creditworthiness of each of a plurality of users, including the historical credit scores for such users). In this model, creditworthiness performance indicators for a period of two years were monitored after a credit scoring date. The techniques described herein can be applied similarly to other scores and other credit data sources.

Score migration can contain information beyond that captured by traditional credit scoring methods. Indeed, in this specific application of migration scores on the Fair Isaac Credit Bureau Risk Score, there may be many reasons to get for example a 700 credit score, and individuals that have a 700 score will have slightly different profiles depending on whether they came from a score of 650 or 750. For example, the downward migrators likely have new trades or new delinquencies; the upward migrators likely have older delinquencies and older trades.

However, predicting score migration, or the closely-related future credit score is not straight forward. Conventional techniques for credit scoring, including FICO scores, also use historical credit bureau to generate such scores. In some implementations, there is substantially no further relevant information which can be captured from such credit bureau data in order to characterize score migration.

In addition, models in which performance definition is end credit score, the single biggest predictor of end credit score is starting credit score. As a result, starting credit score will dominate the model and wash out other more subtle effects. If the modeler chooses to exclude starting credit score from the model, the optimized model will be so heavily correlated with starting credit score that migration effects are often washed out in such models.

With models in which the performance definition is change in credit score, score migration may be correlated with good/bad classic performance. After all, prediction of a “good” indicates that a consumer will have clean credit behavior over the next two years. A consumer's score is likely to trend upward over that time period if they do maintain “good” behavior. Similarly, a consumer who goes “bad”—i.e., has a major delinquency in the next two years—would have a credit score that is lower after two years. As such, the score migration performance definition is a proxy for regular credit score good/bad performance by virtue of its correlation between score and performance, and as a result, predictive effects may be dominated by credit score—a score that was build to optimize such a definition.

In the current application, all users within a population having a credit score (e.g., FICO score) between 650 and 699 at October 2005 were analyzed for a two year period until October 2007. While the results shown apply to the population with FICO at October 2006 of 650-699, similar results have been seen on the larger population with FICO at October 2006 of 600-799.

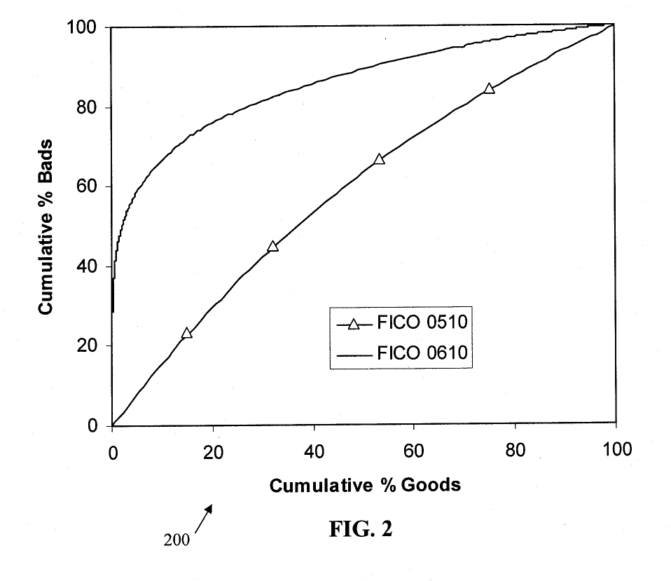

FIG. 2 is a diagram 200 that illustrates percentage of “bad” consumers vs. percentage of “good” consumers for FICO scores obtained in October 2005 (e.g., FICO 0510) and for FICO scores obtained in October 2006 (e.g., FICO 0610). In one variation, “bad” consumers can be characterized as individuals that were delinquent on at least one payment card account for at least three cycles during a pre-defined performance period and “good” consumers can be characterized as individuals that were never delinquent for more than one cycle on any of his or her payment card accounts during a relevant performance period. As is illustrated in FIG. 2, a FICO score at October 2006 predicts performance between October 2005 to October 2007 much better than a FICO score at October 2005. As a result, it can be advantageous to predict a future FICO credit score (or migration from a current credit score).

A migration score predictive model was generated on a population with FICO scores between 650 and 699 on October 2005. The migration score was built using a development sample from a plurality of consumers:

If FICO 0610−FICO 0510>=0, Target=0; Else, Target=1; and

Sample weight=ABS (FICO 0610−FICO 0510).

In other words, the increase or decrease of the FICO score from October 2005 to October 2006 was used as the binary performance definition for the model. The prediction was made using a sample-weight that was equal to the magnitude of the increase or decrease, so one who had a large increase in score was given more weight than one who had a small increase, and the same for score decreasers.

The migration score can be made up of a plurality of variables that characterize creditworthiness during the performance period subsequent to the credit score date including, for example, credit bureau data such as utilization, trade lines, delinquencies, and the like. In other implementations, master file data can be used to generate performance related variables.

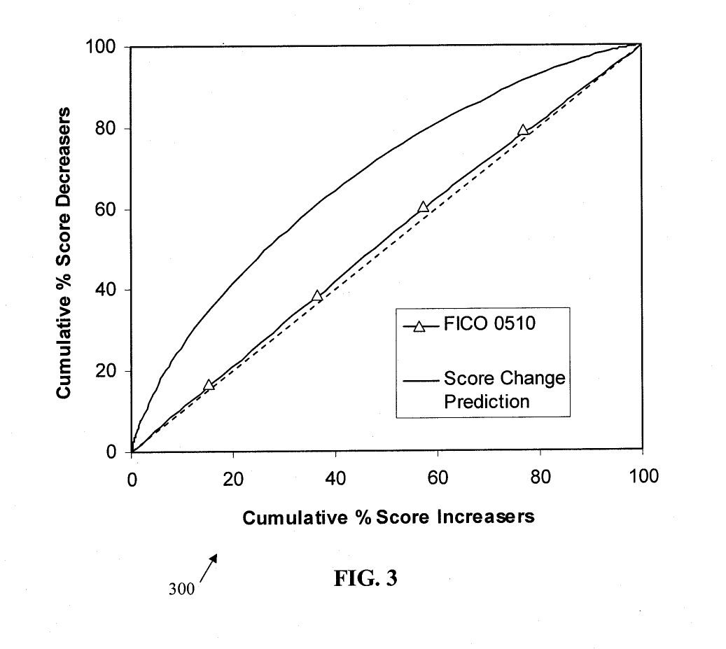

FIG. 3 illustrates a diagram 300 in which results for percentage of cumulative percentage score decreasers vs. cumulative percentage score increasers are shown for a score change prediction (i.e., migration score) relative to a conventional FICO score having a scoring date of October 2005. These results are shown on an independent validation sample in which the sample was weighted so that larger increases count for more than small increases.

Table 1 below illustrates a sample of how one can map migration scores to an absolute score change (e.g., offset to a FICO score) across an arbitrary number of quantiles (in this case 100). As an example If MigrationScore>−1.175 AND <=−1.0888, then Absolute Score Change=−139.

TABLE 1

| Quantile | Migration Score | Absolute Score Change |
|---|---|---|
| 0 | −2.9132 | SV1 |
| 1 | −1.4677 | −196 |
| 2 | −1.2881 | −173 |
| 3 | −1.175 | −156 |
| 4 | −1.0888 | −139 |
| 5 | −1.0173 | −124 |
| . | . | . |
| . | . | . |
| . | . | . |
| 95 | 1.1246 | 66 |
| 96 | 1.1849 | 71 |
| 97 | 1.2613 | 77 |
| 98 | 1.3545 | 85 |
| 99 | 1.5081 | 98 |
| 100 | 2.2147 | 165 |

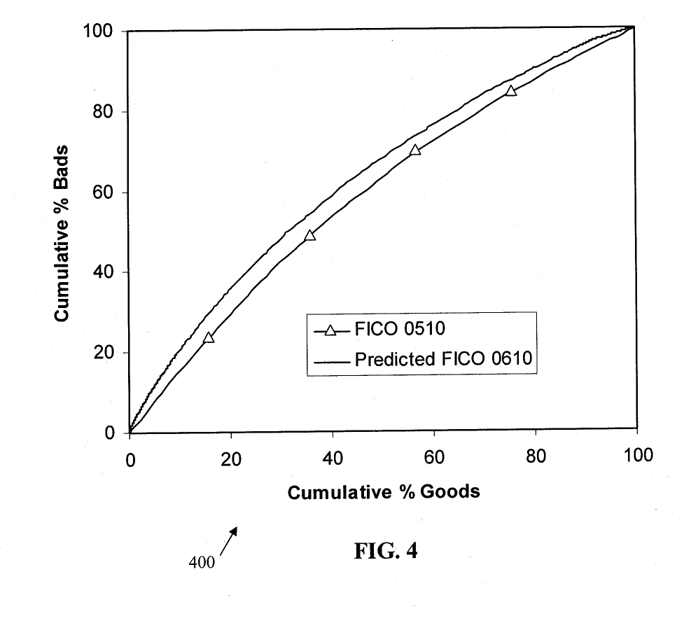

FIG. 4 is a diagram 400 that illustrates percentage of “bad” consumers vs. percentage of “good” consumers for FICO scores obtained relative to FICO scores obtained in October 2005 compared to predicted FICO scores at October 2006. As can be seen, by devising the predicted FICO scores (by incorporating a migration score developed using the techniques described herein), a larger number of “bad” consumers can be identified.

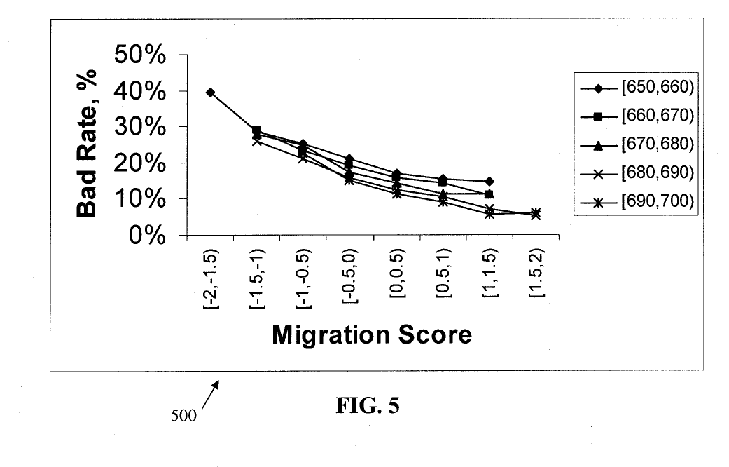

FIG. 5 is a diagram 500 that illustrates the wide range of performance for individuals within bands of the FICO ranges that can be identified by using a migration score. For example, for individuals in the 650-660 FICO range, bad performance rates can range from 40% for those with the lowest migration scores to 15% for those with the highest migration scores).

Using Future Action Impact Modeling (FAIM) (see, for example, U.S. patent application Ser. No. 11/832,610, filed on Aug. 1, 2007, the contents of which are hereby fully incorporated by reference) future score migration can be predicted using models trained using historical data that includes empirical performance data from a plurality of users as well as credit scores for such users. Using FAIM modeling technology, a migration score, based on the modeled population, can be used to refine the risk prediction in order to determine how credit scores might migrate after a scoring date.

The predictive model used herein to generate the migration score can be based, for example, on a scorecard model developed using FAIM and/or the ModelBuilder™ software suite of Fair Isaac Corporation. In some implementations, a divergence-based optimization algorithm can be trained using the data obtained from a large number of consumers as well as subsequent credit bureau (or in some variations master file) payment delinquencies and corresponding credit scores. The underlying model may use a variety of predictive technologies, including, for example, neural networks, support vector machines, and the like in order to predict future creditworthiness of a single user based on historical data from a large number of users.

The score can be used to enhance traditional metrics. For example, in the risk world, those who are likely to become more or less risky over time, have a probability of changing lender exposure to credit risk, and so a migration score to capture this contingent probability would add value to decisions. Alternatively, triggers can be modeled based on the migration score in order to characterize whether consumers are likely to increase/decrease their credit score shortly after the scoring date. Such triggers can be used to flag likely behavior, and or intercede (e.g., change credit limit, etc.) before downward migration occurs, or take advantage before upward migration occurs.

Contextual data can also be used in order to either generate a migration score or to otherwise weight the migration score. For example, length of loan, loan amount, interest rate, type of collateral, and other factors which might relate to the need for a current credit score can be taken into account in order to determine whether future creditworthiness will be positively or negatively affected. Such contextual data can further be built into the predictive model. In some implementations, the contextual data is tied to modeled triggers. For example, if a modeled trigger is that the user exceeds $50,000 in new debt, and the user is applying for a $75,000 loan, then predicted future performance would be negatively affected.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. An article comprising a machine-readable storage medium embodying instructions that when performed by one or more machines result in operations comprising:
receiving, by a first computer system, data comprising a request to generate a migration score, the migration score characterizing a likelihood of a change in a level of creditworthiness of a consumer subsequent to generation of a current credit score;
estimating, by the first computer system, future credit score migration for the individual using a predictive model trained using historical creditworthiness data derived from a plurality of individuals, the historical creditworthiness data including, for each individual, a historical credit score and empirical performance data subsequent to a scoring date for the historical credit score;
associating, by the first computer system, the estimated future credit score migration with a migration score; and
initiating provision of the migration score.

2. An article as in claim 1, wherein the initiating provision of the migration score comprises displaying the migration score on the first computer system.

3. An article as in claim 1, wherein the initiating provision of the credit migration score comprises transmitting data characterizing the migration score from first computer system to a second computer system.

4. An article as in claim 1, wherein the machine-readable storage medium further embodies instructions that when performed by one or more machines result in operations comprising:
receiving user-generated input providing contextual data;
wherein the estimated future credit score migration is based on the provided contextual data.

5. An article as in claim 4, wherein the contextual data characterizes an event requiring credit.

6. An article as in claim 5, wherein the event is a loan, and the contextual data comprises one or more of: loan length, loan amount, interest rate, and type of collateral for loan.

7. An article as in claim 1, wherein the predictive model is a scorecard model.

8. An article as in claim 1, wherein the predictive model identifies a plurality of migration triggers, the migration triggers characterizing events which when occurring, result in a change in creditworthiness of the individual that is above a pre-determined threshold.

9. An article as in claim 8, wherein the machine-readable storage medium embodies further instructions that when performed by one or more machines result in operations comprising:
monitoring creditworthiness data for the individual subsequent to the provision of the migration score to identify the occurrence of one or more events characterizing one or more migration triggers; and
initiating an alert indicating that a migration trigger has been triggered.

10. An article as in claim 9, wherein the machine-readable storage medium embodies further instructions that when performed by one or more machines result in operations comprising:
generating an updated migration score based on the event triggering the migration trigger; and
initiating provision of the updated migration score.

11. A method to be performed by execution of computer readable program code by at least one processor of one or more computer systems, the method comprising:
receiving data comprising a request to generate a migration score, the migration score characterizing a likelihood of a change in a level of creditworthiness of a consumer subsequent to generation of a current credit score;
estimating future credit score migration for the individual using a predictive model trained using historical creditworthiness data derived from a plurality of individuals, the historical creditworthiness data including, for each individual, a historical credit score and empirical performance data subsequent to a scoring date for the historical credit score;
associating the estimated future credit score migration with a migration score; and
initiating provision of the migration score.

12. A method as in claim 11, wherein the initiating provision of the migration score comprises displaying the migration score.

13. A method as in claim 11, wherein the initiating provision of the credit migration score comprises transmitting data characterizing the migration score to a remote computer system.

14. A method as in claim 11 further comprising:
receiving user-generated input providing contextual data;
wherein the estimated future credit score migration is based on the provided contextual data.

15. A method as in claim 14, wherein the contextual data characterizes an event requiring credit.

16. A method as in claim 15, wherein the event is a loan, and the contextual data comprises one or more of: loan length, loan amount, interest rate, and type of collateral for loan.

17. A method article as in claim 11, wherein the predictive model is a scorecard model.

18. A method as in claim 11, wherein the predictive model identifies a plurality of migration triggers, the migration triggers characterizing events which when occurring, result in a change in creditworthiness of the individual that is above a pre-determined threshold.

19. A method as in claim 18 further comprising:
monitoring creditworthiness data for the individual subsequent to the provision of the migration score to identify the occurrence of one or more events characterizing one or more migration triggers; and
initiating an alert indicating that a migration trigger has been triggered.

20. A method as in claim 19 further comprising:
generating an updated migration score based on the event triggering the migration trigger; and
initiating provision of the updated migration score.
